(19) United States
(12) Patent Application Publication
(10) Pub. No.: US 2023/0057753 A1
(43) Pub. Date: Feb. 23, 2023

(54) KITCHEN APPLIANCE BASE, PREPARATION MODULE AND KITCHEN APPLIANCE

(71) Applicant: Vorwerk & Co. Interholding GmbH, Wuppertal (DE)

(72) Inventor: Christian Bayard, Witten (DE)

(21) Appl. No.: 17/888,537

(22) Filed: Aug. 16, 2022

(30) Foreign Application Priority Data
Aug. 20, 2021 (EP) 21192449.3

(51) Int. Cl. A47J 43/08; A47J 43/046

(52) U.S. Cl. CPC A47J 43/085; A47J 43/046

(57) ABSTRACT

A kitchen device base having at least one collection area for at least one preparation module, whereby the collection area has at least one locking means for mechanical locking of the preparation module. A kitchen device base, a preparation module, and a kitchen device, with which automatic locking of various preparation modules on a kitchen device base is made possible, are realized in that the locking means has at least one drive unit and at least one movably mounted locking element, that the locking element can be moved at least indirectly by means of the drive unit, at least between a release position and a locking position, that in the release position the preparation module can be arranged in at least two different orientations in the collection area, and that in the locking position the preparation module is locked to the kitchen device base.

### CROSS REFERENCE TO RELATED APPLICATIONS

This application claims the benefit of priority under 35 U.S.C. § 119 to European Patent Application No.: 21192449.3, filed Aug. 20, 2021, the contents of which is incorporated herein by reference in its entirety.

### FIELD

The invention concerns a kitchen device base with at least one collection area for at least one preparation module. Furthermore, the invention concerns a preparation module to be placed in a collection area of a kitchen device base as well as a kitchen device that comprises a kitchen device base as well as at least one preparation module. For the purpose of mechanically locking the preparation module to the kitchen device base, the kitchen device base may have at least one locking means.

### BACKGROUND

The statements in this section merely provide background information related to the present disclosure and several definitions for terms used in the present disclosure and may not constitute prior art.

Kitchen devices with a kitchen device base and preparation module are known from conventional technology in a multitude of designs. Such kitchen devices serve for automatic, semi-automatic, or manual preparation—for example for chopping, grinding, pressing, stirring, cooking, or keeping warm—especially foods. The kitchen device typically has a kitchen device base which provides a collection area for at least one preparation module. The collection area often has at least one electrical interface in order to provide a preparation module which has been inserted into the collection area with working voltage, for example for a heating system, or for example to make contact with sensors.

Alternatively or additionally, at least one drive interface is provided in the collection area, which for example serves to transfer torque from a working unit, for example a motor, of a kitchen device base for example to a tool which is arranged on the preparation module.

Additionally, the kitchen device base typically has a locking means in order to prevent the removal of the preparation module after being locked to the kitchen device base. Locking ensures a safe working process and in particular prevents accidental removal of the preparation module during the working process. The locking process of kitchen devices is often performed manually, in that a bayonet catch is formed between the preparation module and the kitchen device base, which is locked in that the user rotates the preparation module in the collection area by a predetermined angle.

Furthermore, kitchen device bases with automatic locking means are known. The locking means have, for example, movable locking arms which are held on the kitchen device base at the approximate height of a lid of a preparation module. The locking arms can be rotated between a locking position and a release position.

Although the kitchen devices with automatic locking means which are known from conventional technology already ensure a high level of user safety and advantageous ease of use, they can only be operated with preparation modules with a standardized basic configuration due to the location of the locking means away from the kitchen device base.

It is therefore an objective of the present disclosure to provide a kitchen device base, a preparation module, and a kitchen device which enable the automatic locking of a variety of preparation modules on a kitchen device base.

### SUMMARY

The aforementioned objective of the present disclosure is achieved with a generic kitchen device base with at least one collection area for at least one preparation module, whereby the collection area has at least one locking means for the purpose of mechanical locking of the preparation module. The locking means has at least one drive unit and at least one movably mounted locking element. The locking element is at least indirectly movable via the drive unit, at least between at least one release position and at least one locking position, so that the preparation module can be locked with the kitchen device base, and the lock can be disengaged. When in the release position, the preparation module can be arranged in at least two different orientations in the collection area, and when in the locking position, the preparation module is locked to the kitchen device base.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows a perspective view of a kitchen device with a kitchen device base and preparation module according to the teachings of the present disclosure;

FIG. 2 shows a perspective view of a kitchen device base with a locking means of a first type and power contacts of a first type;

FIG. 3 shows a perspective view of a kitchen device base with a locking means of a second type and power contacts of a first type;

FIG. 4 shows a perspective view of a kitchen device base with a locking means of a second type and power contacts of a second type in a first state;

FIG. 5 shows a perspective view of the kitchen device base according to FIG. 4 in a second state;

FIG. 6 shows a partial view of a kitchen device base according to the teachings of the present disclosure;

FIG. 7 shows a perspective view of a locking element according to the teachings of the present disclosure;

FIG. 8 shows a top-down view of a kitchen device base in a first state;

FIG. 9 shows a top-down view of the kitchen device base according to FIG. 8 in a second state;

FIG. 10 shows a sectional view of a kitchen device base with a preparation module;

FIG. 11 shows a perspective view of a preparation module from the underside;

FIG. 12 shows a perspective view of a foot section of a preparation module;

FIG. 13 shows a perspective view of another foot section of a preparation module;

FIG. 14 shows a perspective view of a locking element for a preparation module;

FIG. 15 shows a perspective view of a foot area of a preparation module;

FIG. 16 shows a perspective view of a locking element with drive lever and drive unit; and

FIG. 17 shows a perspective view of a preparation module in a partially assembled state.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

In general, the kitchen device base comprises at least one collection area for at least one preparation module, whereby the collection area has at least one locking means for the purpose of mechanical locking of the preparation module. The locking means has at least one drive unit and at least one movably mounted locking element, such that the locking element can be moved at least indirectly by means of the drive unit, at least between a release position and a locking position, that in the release position the preparation module can be arranged in at least two different orientations in the collection area, and that in the locking position the preparation module is locked to the kitchen device base.

In the release position of the locking element, a preparation module can be arranged in at least two different orientations in the collection area. In this context, “two different orientations” means that the preparation module can be arranged in at least two different orientations, in particular rotated with respect to one another, in the one collection area. An operating means of the preparation module is, for example, oriented to the right in a first orientation, and, for example, oriented to the left in a second orientation.

In the locking position, the locking of the preparation module with the kitchen device base is effected. Upon moving the locking element in the direction of the locking position, the kitchen device base and a preparation module located in the collection area, preferably in a form-fitting manner, preferably in the collection area, are connected with one another, so that the preparation module can no longer be removed from the collection area. In particular, the preparation module is locked at least axially, so that forces with at least a portion in a direction parallel to a central axis A can be transferred via the locking element.

The collection area of the kitchen device base is configured and designed for connecting with the preparation module. Preferably, the preparation module is at least partially accommodated in the collection area. The collection area for the preparation module may be at least partially designed in terms of its shape to essentially correspond to a foot section of the preparation module, in particular in order to accommodate the preparation module at least partially in a form-fitting manner. The collection area is designed in particular in such a way that a rotation of the preparation module relative to the kitchen device base is already prevented by the at least two defined orientations. With regard to the two orientations relative to the kitchen device base, a form fit that prevents rotation is already prevented upon placement of the preparation module in the collection area.

The drive unit may have at least one drive means, in particular at least one rotating electric motor and/or at least one linear motor. Furthermore, the drive unit has at least one transmission means connected to the drive means, in particular at least one gear, for example a worm, spur, and/or bevel gear, and/or a drive belt and/or a drive chain. The drive means may be connected to at least one gearbox. In particular, the gearbox has multiple gear wheel. The drive unit is in particular directly or indirectly connected to the movably mounted locking element, so that the locking element can be moved by the drive unit at least between at least one release position and at least one locking position.

Furthermore, it is provided that the drive unit has at least one clutch device, for example at least one slip clutch. The clutch device may be designed and arranged in the drive unit such that it is triggered when at least one threshold value for a force during a movement and/or a torque is exceeded in order to prevent damage to the drive unit and/or other components of the kitchen device base and/or of the preparation module.

The locking element is configured and designed such that a preparation module can be arranged in the release position in at least two, alternatively, exactly two, different orientations, preferably in two orientations offset from one another by at least 90°, in particular by 180°, in the collection area. The locking means is designed such that it can be locked in each of the arrangements. For example, the preparation module can be arranged and locked in at least two, in particular exactly two, at least three, in particular exactly three, or at least four, in particular exactly four, orientations in the collection area.

During or after arrangement of the preparation module in the collection area, the locking element is moved in the direction of the locking position, so that locking, in particular an axial locking, of the preparation module with the kitchen device base is achieved at the latest when the locking position is reached. The preparation module is locked in the collection area to the kitchen device base.

For example, the movement of the locking element leads to at least one locking section of the locking element interacting in a form-fitting manner with at least one locking counter-section of the preparation module. The preparation module can thus be locked together with the kitchen device base by moving the locking element. Preferably at least two, in particular exactly two, at least three, preferably exactly three, or at least four, preferably exactly four locking sections and/or locking counter-sections are provided. The locking sections and locking counter-sections are arranged such that a preparation module can be arranged in the release position of the locking element in at least two, preferably exactly two, different orientations, preferably in two orientations offset from one another by at least 90°, in particular by 180°, in the collection area. Furthermore, it is preferably provided that the locking sections and locking counter-sections are arranged such that the preparation module can be arranged and locked in at least three, in particular exactly three; or at least four, preferably exactly four orientations in the collection area.

The kitchen device base may have at least one housing on which the collection area for collection of at least one preparation module is designed. The collection area may be arranged essentially in a plane E, which is designed essentially parallel to a stand space of the kitchen device base in normal use. Preferably, the kitchen device base has at least one working unit with at least one electric motor, the torque of which can be transmitted via a drive interface in the collection area. A torque is transmitted, for example, via a corresponding drive interface of a preparation module to a shaft or to a tool arranged in the preparation module, for example a stirring and/or chopping tool. Alternatively or additionally, the kitchen device base has at least one weighing device for weighing foods located in the preparation module and also has at least one mains connection for providing electrical power.

The kitchen device base also has, for example, at least one electrical interface. In particular, the electrical interface is designed for making electrical contact with a preparation module that can be arranged in the collection area. Preferably, the electrical interface is arranged in the collection area. In the state of being inserted into the collection area, the electrical interface makes electrical contact in particular with an electrical counter-interface on the preparation module.

Additionally, the kitchen device base may include a control unit. The drive unit is preferably controlled by the control unit of the kitchen device base. In particular, the control unit causes a movement in the direction of the release position or the locking position. The control unit may include power electronics to operate at least one heating device, for example a preparation module, which is in electrical contact with the electrical interface.

In comparison with conventional technology, the invention of the present disclosure has the advantage that different preparation modules can be automatically locked to the kitchen device base. Furthermore, the preparation modules can be placed on the kitchen device base in various orientations, so that, for example, different requirements for left-handed and right-handed users can be accommodated.

It has proven to be particularly advantageous according to a first embodiment of the kitchen device base if it is provided that the locking element can be rotated by the drive unit. The drive unit thereby engages the locking element either directly or indirectly. It is advantageously provided that the drive unit interacts with a rack gear of a drive lever, whereby the drive lever is connected with the locking element in a form-fitting manner, in particular by two pins. The pins are in particular designed as a single component with the locking element and are arranged in corresponding recesses in the drive lever. A movement of the drive lever via the drive unit thus directly effects a movement, in particular rotation, of the locking element.

The drive unit may be arranged such that the locking element and/or the drive lever can be operated from outside of their respective axis of rotation. Preferably, the locking element and/or the drive lever can be rotated around an axis which also corresponds to the axis of rotation of a working unit, in particular a motor, for driving a tool, preferably within a preparation module. A shaft may be arranged centrally in the kitchen device base for transmitting torque to a tool, so that it is surrounded by the locking element and/or the drive lever. In particular, the drive lever and/or the locking element have a central recess. The drive lever is, for example, ring-shaped, disc-shaped, or designed as a circle segment. It is also provided in particular that, in place of the drive lever, multiple spur gear stages are arranged, which interact with the locking element.

To create the form-fitting connection between the drive lever and the locking element, it is provided according to a further embodiment that the locking element, in particular the two pins, at least partially penetrate through a base plate, which is arranged in particular on the top side of the kitchen device base.

The locking element may be designed as a locking ring which is arranged on one top side of the kitchen device base in the collection area. Preferably, the locking ring is arranged between a surface of the kitchen device base and an insulator module which is arranged on the surface of the kitchen device base. The insulator module may be held in a stationary and rotationally fixed manner relative to the surface of the kitchen device base. The locking ring thus moves relative to the top side of the kitchen device base and to the insulator module.

In particular, at least the section of the locking element that protrudes between the insulator module and the surface of the kitchen device base is ring-shaped.

In particular, in order to decrease the installation space for the locking means, it has proven to be advantageous according to a further embodiment if the locking element is movable in a locking plane. Preferably, the locking plane is aligned essentially parallel to a stand space of the kitchen device base or a surface of the kitchen device base. The stand space is the stand space on which the kitchen device base is placed for normal use. The surface of the kitchen device base is the surface of the housing on which the collection area is arranged and on which the preparation module is placed. When a preparation module is arranged in the collection area, the locking element may be arranged essentially between the upper side of the kitchen device base and the preparation module.

The locking element acts for example directly together with the preparation module for locking, or the locking element causes the preparation module to be locked to the kitchen device base. In particular in the case of embodiment examples in which the locking element interacts directly with the preparation module to effect the locking function, it has proven to be particularly advantageous if it is provided that the locking element has at least one locking section, and that the locking section, when in the locking position with the preparation module arranged in the collection area, interacts with at least one locking counter-section of the preparation module in a form-fitting locking manner. In the release position, the locking section and the locking counter-section are arranged such that the preparation module can be removed from the collection area, in particular essentially in the direction of a central axis A.

It is advantageously provided that the locking element has at least two locking sections, which each interact with an associated locking counter-section of the preparation module in a form-fitting manner. In particular it is provided that the at least two locking sections are arranged essentially opposite one another on a circumference of the locking element.

For example, the locking section has a hook-shaped or step-shaped cross-section, or is be hook-shaped or step-shaped, so that at least part of the locking section can be moved, in particular rotated, into a form-fitting interaction with a locking counter-section on a preparation module. In this embodiment example, the locking element consequently rotates into the form-fitting lock with the preparation module, in particular with a footer area of the preparation module. This embodiment offers the advantage that the components required for the locking action can be constructed very flat.

According to a further alternative embodiment of the kitchen device base according to the invention, it is provided that the locking element has at least one driver contour. The driver contour is designed to interact with a driver counter-contour on a locking counter-ring on the preparation module. The driver contour on the locking element protrudes on the locking element, for example. Preferably, at least two driver contours are provided on the locking element, which are arranged in particular opposite one another on a circumference. In particular, at least three, exactly three, at least four, or exactly four driver contours as well as associated driver counter-contours are provided. The driver contours and the driver counter-contours are arranged such that the preparation module can be arranged in at least two orientations in the collection area when in the release position.

The driver contour is designed such that it can interact in a form-fitting manner with a driver counter-contour on a locking counter-element, in particular a locking counter-ring, on the preparation module. In particular, a rotation of the locking element onto the locking counter-element on the preparation module can be transmitted via the driver contour. For example, the driver contour is designed as a carrier rib and/or the driver counter-contour is designed as a corresponding driver gap. The form-fitting joining of the driver contour and the driver counter-contour takes place by the placement of the preparation module in the collection area.

The locking counter-element is rotatably mounted, in particular in a foot section of the preparation module. At least one locking section, in particular at least two locking sections, are formed on the locking counter-element. The locking counter-element can be moved by the locking element between a release position and a locking position. When the locking element is in the locking position, the locking counter-element is also in the locking position. When the locking element is in the release position, the locking counter-element is also in the release position.

In the locking position, the locking section or locking sections of the locking counter-element interact in a form-fitting manner with at least one locking contour on the top side of the kitchen device base, whereby the preparation module is connected in a form-fitting manner with the kitchen device base. Preferably, there are at least two, in particular exactly two, at least three, in particular exactly three, at least four, in particular exactly four, at least five, in particular exactly five, or at least six, in particular exactly six locking contours provided on the top side of the kitchen device base. Each locking contour preferably extends from a top side of the kitchen device base, in particular essentially vertically in an upward direction.

The locking contour or the locking contours are preferably hook-shaped, so that respective locking section of the locking counter-element can rotate under the hook-shaped locking contours in order to lock a preparation module with the kitchen device base.

The locking contours may be designed and configured such that they define the collection area of the kitchen device base.

For example, the locking contours have lead-in chamfers to position the preparation module in the collection area. Preferably, at least the locking counter-ring has a number of recesses corresponding to the number of locking contours, in particular in a circumferential locking section, on order to enable the placement of the preparation module on the kitchen device base.

For making electrical contact between the preparation module and the kitchen device base, it has proven to be particularly advantageous if an electrical interface is arranged on the kitchen device base, in particular in the collection area, and if the electrical interface has at least two power contacts and at least one auxiliary contact. The electrical interface serves to make electrical contact with an electrical counter-interface on the preparation module. In order to advantageously reduce the contact forces when inserting the preparation module into the collection area of the kitchen device base, it is provided that at least one of the power contacts and/or at least the auxiliary contact of the electrical interface is movable—preferably at least indirectly by means of the drive unit—from a resting position at least in the direction of a contact position on the kitchen device base. The electrical interface preferably has at least two, at least three, or at least four power contacts. For example, at least two, at least three, or at least four power contacts and/or at least one, at least two, at least three, at least four, at least five, at least six, at least seven, or at least eight auxiliary contacts are provided. For example, the auxiliary contacts are arranged symmetrically on the kitchen device base such that a preparation module can be arranged in at least two different orientations.

Insofar as only a single auxiliary contact is provided, this is in particular designed and arranged such that it can make electrical contact in two different arrangements of a preparation module. For example, the auxiliary contact extends at least over part of a peripheral surface, in particular of an insulator module, in the collection area.

The auxiliary contacts are designed, for example, for the purpose of measuring, controlling, and/or regulating. Preferably, at least one auxiliary contact is designed as a protective conductor and/or at least two auxiliary contacts are designed as signal contacts, in particular for at least one temperature sensor, preferably a thermocouple, of the preparation module, and/or at least one auxiliary contact is designed as a cover contact, and/or at least one auxiliary contact is designed for transmission of data and/or signals to the preparation module, and/or at least one auxiliary contact is designed to supply voltage to components in a preparation module with voltages that are non-critical for contact.

In particular, it is provided that the movement of the power contact or the power contacts and/or the auxiliary contact is controlled such that the power contacts or the auxiliary contact are in a contact position when the locking element is in a locking position. Likewise, the power contacts and/or the auxiliary contact are in a resting position when the locking element is in a release position.

The movement of the power contacts or the auxiliary contact out of the resting position may occur at least in the direction of the contact position during and/or after the insertion of the preparation module into the collection area. It is therefore provided that a movement of the power contacts and/or the auxiliary contact begins while a preparation module is being arranged in the collection area and is completed after the insertion. It is also provided that the movement of the power contacts and/or the auxiliary contact only begins after the preparation module has been arranged in the collection area.

For example, it is provided that the movement of the power contact or power contacts and/or the auxiliary contact from the resting position in the direction of the contact position takes place at the same time as the movement of the locking element of the locking means. Locking and electrical contact may take place at least partially or completely simultaneously, in particular under the action of the drive unit. It is also provided that the electrical contact is made at a different point in time than the mechanical locking of the preparation module with the kitchen device base, for example before the mechanical locking or after the mechanical locking. It is also provided that the electrical contact takes place at least partially simultaneously and at least partially before or after locking. For example, the auxiliary contacts make electrical contact before the mechanical locking and the power contacts make electrical contact at least partially simultaneously, completely simultaneously with the mechanical locking, or the power contacts make electrical contact after the mechanical locking.

In particular, it is provided that the locking element is moved at least partially simultaneously, in particular completely simultaneously, with the at least one power contact and/or at least with the auxiliary contact in order to lock a preparation module. Alternatively, it is also provided that the locking element is moved before or after the at least one power contact and/or at least the auxiliary contact in order to lock a preparation module.

The drive unit is, for example, mechanically connected both to the locking element of the locking means and to the power contacts and/or the auxiliary contact, so that the drive unit effects all movements automatically. Preferably, it is provided that all power contacts and/or auxiliary contacts can be moved between a resting position and a contact position. It is also provided, for example, that the contact and resting positions for the power contacts and the auxiliary contacts are different.

When a preparation module is arranged in the collection area, when in the contact position the power contacts make electrical contact with power counter-contacts of the preparation module. Alternatively or additionally, when in the contact position, the auxiliary contact or auxiliary contacts make contact with an auxiliary counter-contact or with multiple auxiliary counter-contacts. “Making electrical contact” in this case does not mean the actual application of voltage or current, but only physical contact, which in principle enables the conducting of electricity or signals.

For example, it is provided that both power contacts are movable and can be contacted or are contacted with power counter-contacts that are designed as contact blades. Preferably, the auxiliary contact and the auxiliary counter-contact or the auxiliary contacts and the auxiliary counter-contacts are each stationary, and are in particular designed as spring loaded contact clamps. In particular it is provided that the power contacts are designed as a first interface type and the auxiliary contact or auxiliary contacts are designed as a second interface type. The first and second interface type are designed differently.

The movement of the power contact or the power contacts and/or of the auxiliary contact or auxiliary contacts takes place in a rotating manner, a translational manner, or as a combination of the two. The movement occurs, for example, radially, i.e. in a plane that is, for example, parallel to a stand space of the kitchen device base, or axially, i.e. in a direction that is orthogonal to a stand space of the kitchen device base. It is also provided that the movement occurs in a direction that is inclined with respect to the stand space of the kitchen device base.

Alternatively or additionally, it is provided that at least one of the power counter-contacts, preferably both power counter-contacts, and/or at least the auxiliary counter-contact or the auxiliary counter-contacts of the counter-interface of the preparation module can be moved from a resting position at least in the direction of a contact position on the preparation module. The power counter-contact or the power counter-contacts or the auxiliary counter-contact are therefore movably mounted on the preparation module and, like the contacts of the electrical interface, are moved from a resting position at least in the direction of a contact position, preferable between a resting position and a contact position.

This embodiment example has the advantage in comparison with conventional technology that the placement of the preparation module in the collection area is simplified. The contact forces for the user are reduced because electrical contact is made with at least one contact of the electrical interface, preferably all contacts, only after placement of the preparation module in the collection area.

According to a further design of the kitchen device base according to the invention, it is advantageously provided that at least one of the power contacts, at least the auxiliary contact, at least one of the power counter-contacts and/or at least the auxiliary counter-contact can be moved at least indirectly by means of the drive unit. The drive unit is, for example—as previously described—arranged in the kitchen device base and is also used for locking and/or an additional drive unit is arranged in the preparation module and/or a movement of the drive unit of the kitchen device base is transmitted to the power counter-contacts or the auxiliary counter-contact when it is brought into the collection area.

The drive unit has a mechanical connection at least indirectly, in particular directly, to the power contacts, the auxiliary contact, the power counter-contacts, and/or the auxiliary counter-contact, so that these can be moved by the drive unit.

For the purpose of moving the power contact or the power contacts and/or the auxiliary contact or the auxiliary contacts, these are at least indirectly, in particular directly, in contact with the previously-described drive lever. Preferably, the power contacts are housed in insulators, whereby each insulator engages with a drive protrusion into a backplate recess on the drive lever. The drive protrusions interact with the backplate recesses such that a rotation of the drive lever causes a translational movement of the insulator with the power contacts.

Furthermore, the invention concerns a preparation module, in particular for a kitchen device base, according to one of the previously-described embodiment examples. The preparation module is designed to be arranged in a collection area of a kitchen device base, as described above. The preparation module preferably has, in particular in its foot section, at least one electrical counter-interface—as previously described—for making electrical contact with an electrical interface of the kitchen device base. The preparation module is locked, in particular in its foot section, in particular from below, to the kitchen device base, in particular to the collection area of the kitchen device base.

The preparation module has a movable, in particular rotatable, mounted locking counter-element. The locking counter-element is preferably designed as a locking counter-ring. The locking counter-element is mounted on a housing of the preparation module. When in the state of being installed in the collection area, the locking counter-element can be moved by the locking element of the kitchen device base—as previously described—at least between a locking position and a release position.

The locking counter-element is designed such that the locking element of the kitchen device base can engage in a form-fitting manner in at least two positions of the locking counter-element, in particular along a circumference of the locking counter-element, for the purpose of moving, in particular for rotating. This ensures that the preparation module can be placed on the kitchen device base or arranged in the collection area in at least two different orientations.

For this purpose, the locking counter-element has at least two driver counter-contours which can interact with at least one driver contour on the locking element of the kitchen device base. The driver contours and/or the driver counter-contours preferably have lead-in chamfers for easier assembly. If the kitchen device base has only a single driver contour on the locking element, then depending on the orientation of the preparation module, this can engage in one or the other driver counter-contour of the locking counter-element. If two driver contours are designed on the locking element of the kitchen device base, these can each engage in both driver counter-contours, alternating depending on the orientation of the preparation module. This applies to any number of driver contours and driver counter-contours.

The locking element causes—while it moves itself from its release position into its locking position—a movement of the locking counter-element from a release position into a locking position, whereby in the locking position—as previously described—a locking section of the locking counter-ring interacts with locking contours on a top side of the kitchen device base in a form-fitting manner, whereby the preparation module is locked to the kitchen device base.

It is also provided that the locking counter-element is operatively connected to at least one power counter-contact, in particular all power counter-contacts, and/or at least the auxiliary counter-contact, in particular all auxiliary counter-contacts, such that a movement of the locking counter-element into the locking position causes a movement of at least the power counter-contact and/or at least the auxiliary counter-contact from a resting position into a contact position on the preparation module.

According to a further embodiment, it has proven to be particularly advantageous if the locking element has at least one circumferential groove and the locking element is rotatably mounted on the preparation module, in particular in a foot section of the preparation module, by means of the groove. Provision is preferably made for a circumferential web on the preparation module to engage in the groove on the locking counter-element, so that the locking ring is mounted on the preparation module so that it can rotate, but is stable and cannot tilt. High forces can be transmitted when the web engages in the circumferential groove.

According to a further embodiment of the preparation module, there is at least one preparation space and the preparation space can be closed with at least one lid. The preparation module also has at least one lid locking device. The lid locking device is operationally connected with the locking counter-element, so that with the lid locking device can be used to lock at least one lid that can be arranged on the preparation module, at least in the locking position of the locking counter-element. Preferably, the locking counter-element and the lid locking device are coupled such that the lid is locked when the locking counter-element is in its locking position, and the lid is released when the locking counter-element is in its release position.

Furthermore, it is provided, for example, that the locking counter-element and the lid locking device are coupled or controlled such that in a first step, the preparation module is locked to the kitchen device base and subsequently in a second step, in particular with a time delay or based on a prompt or action by a user, the lid is locked with the preparation module. This makes it possible for a user to remove the lid of the preparation module when the preparation module is locked to the kitchen device base, for example to place food inside.

The lid locking device includes a way to lock the lid to the preparation module under the effect of the rotation of the locking counter-element. For this purpose, the lid locking device has, for example, a rotatable rod or a gear. In addition to locking the preparation module to the kitchen device base, the lid is locked to the preparation module—if present—simultaneously.

The preparation module preferably has at least one electrical heating device, in particular at least two electrical heating devices. Each electrical heating device makes electrical contact via the electrical counter-interface. For example, the preparation module has at least one tool, for example a grating tool, a stirring tool, and/or a crushing tool. It is also provided that the tool is designed, for example, as a fruit and/or vegetable press or grater. It is provided that the functions of the aforementioned tools are combined into one tool. In particular, the preparation module has at least one drive interface to transmit torque from a working unit, such as a motor of the kitchen device base to a tool which is arranged in the preparation module.

A control unit of the kitchen device, in particular of the kitchen device base controls, for example, at least partially automatically or automatically, a heating process of the preparation module or a food preparation process. Preferably, program sequences for the preparation of foods, such as recipes, can be controlled, in particular partially automatically or automatically, with the control unit. Preferably, the kitchen device base or the kitchen device is designed for automatic, semi-automatic, or manual preparation, for example crushing, grinding, pressing, stirring, cooking, and/or keeping warm, especially of food.

The preparation module preferably has an interior preparation space for accommodating food. The preparation module is designed, for example, as a preparation pot, in particular with at least one integrated heating device and at least one integrated stirring device. Foods can be heated with the heating device. Foods can be stirred or chopped with the stirring device.

It is also provided that the preparation module has at least one heating surface as a heating module, which can be heated by means of at least one heating device, and upon which at least one vessel, in particular a pot or a wok or a pan, can be placed.

The present invention also concerns a kitchen device which has at least one kitchen device base, in particular according to one of the previously described embodiment examples, and at least one preparation module, in particular according to one of the previously described embodiment examples. The kitchen device according to the invention is configured and designed in particular for the preparation of foods.

The kitchen device may be configured and designed such that contact is made by moving the power contacts, and locking takes place automatically after the preparation module has been inserted into the collection area of the kitchen device base.

Additional advantageous configurations of the invention arise from the following descriptions of the figures. Identical parts are always marked with the same reference numerals in the various figures of the illustration.

For the following description, it is claimed that the invention is not limited to the embodiment examples and is mot limited not to all or more features of the described feature combinations. Rather, each individual partial feature of each and every embodiment example is also detached from all other partial features described in connection with it, and also in combination with any features of another embodiment example of importance for the subject matter of the invention.

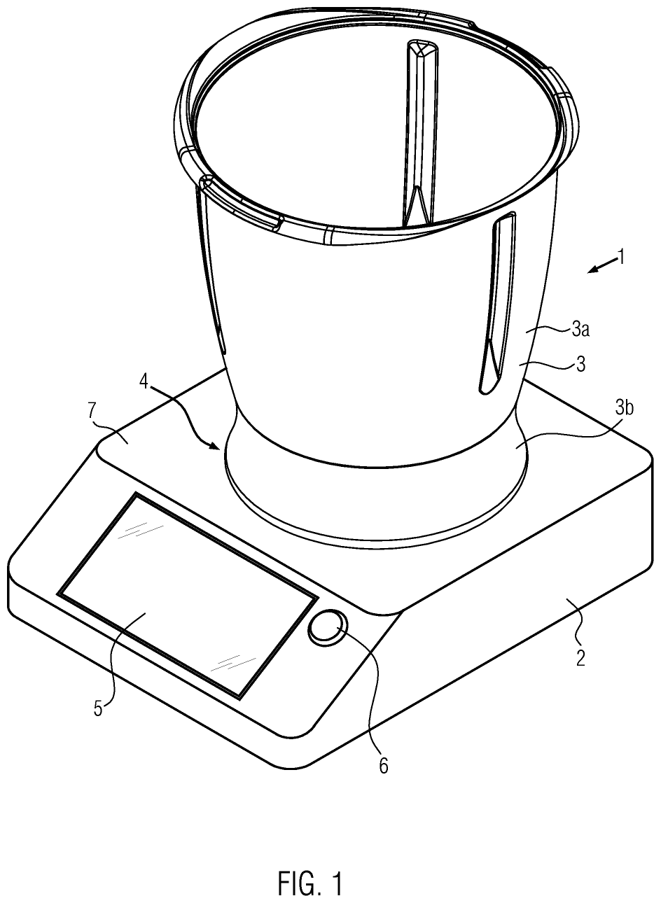

FIG. 1 shows an embodiment example of a kitchen device 1, featuring a kitchen device base 2 and a preparation module 3. According to FIG. 1, the preparation module 3 is arranged in a collection area 4 of the kitchen device base 2. The kitchen device base 2 has an operating and display unit 5. Additionally, at least one operating means 6, which is embodied here as a knob that can be pushed and turned, can be present. With the operating and display unit 5 and the operating means 6, functions can be controlled and programs, in particular preparation programs, can be started. A top side 7 of the kitchen device base 2 is essentially flat and formed parallel to a stand space of the kitchen device base 2 in normal use.

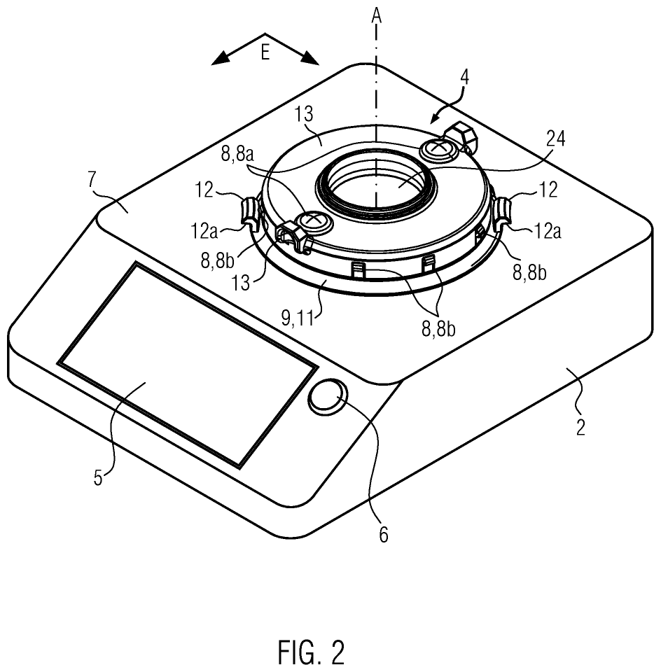

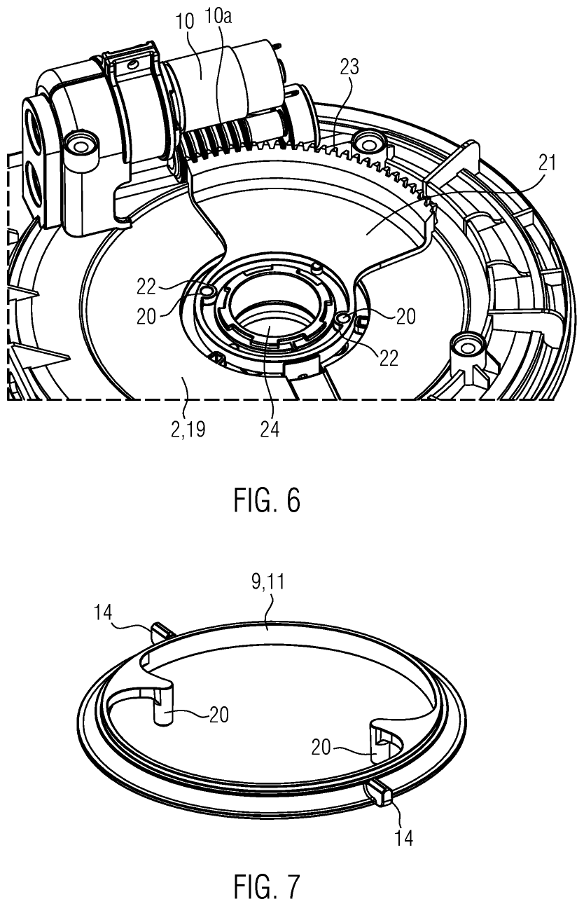

FIG. 2 shows an embodiment example of a kitchen device base 2 without a preparation module 3 attached, in a perspective view. In the collection area 4 on the top side 7 of the kitchen device base 2, there is an electrical interface 8, which has two power contacts 8a and a total of eight auxiliary contacts 8b. In addition, a locking means 9 for mechanically locking a preparation module 3—shown in FIG. 1.—is formed in the collection area 4. The locking means 9 has at least one drive unit 10—illustrated by way of example in FIGS. 6, 10, and 15—and a movably mounted locking element 11. In this embodiment example, the locking element 11 is designed according to FIG. 1 as a locking ring.

The locking element 11 is rotatable, in particular around a central axis A, held on the kitchen device base 2. The locking element 11 is movable below the auxiliary contacts 8b. The drive unit 10 is arranged outside of the drive axis A. The locking element 11 is retained in a locking plane E, which is essentially parallel to the top side 7 of the kitchen device base 2. The locking element 11 is movable via the drive unit 10 between at least one locking position and one release position.

In the release position, a preparation module 3 can be arranged in the collection area 4 in at least two different orientations. In the locking position, the preparation module 3 is locked to the kitchen device base 4. For this purpose, two locking sections 12 are provided on the locking element 11, arranged opposite one another. The locking sections 12 feature an essentially step-shaped cross-section. With a rotation of the locking element 11, these step-shaped locking sections 12 are brought into a form-fitting engagement with a locking counter-section formed on the preparation module 3, so that the preparation module 3 is locked in a form-fitting manner with the kitchen device base 2 and can no longer be removed from the collection area 4. In the locked position, the kitchen device base 2 can be put into operation together with the preparation module 3, i.e. the kitchen device 1.

In the embodiment example of FIG. 1, when a preparation module 3 is arranged in the collection area 4, both the power contacts 8a and the auxiliary contacts 8b with their associated power counter-contacts—not depicted—as well as associated auxiliary counter-contacts—not depicted—of the preparation module 3 are brought into electrical contact, so that electrical contact is made with the preparation module 3. The power contacts 8a serve, for example, to operate a heating device arranged in the preparation module 3. The auxiliary contacts 8b serve, for example, to make electrical contact with a protective conductor and/or two auxiliary contacts 8b serve for transmitting signals for at least one temperature sensor arranged in the preparation module 3, in particular at least one thermocouple, and/or at least one auxiliary contact 8b serves to make electrical contact with a lid contact of the preparation module 3. The power contacts 8a and the auxiliary contacts 8b are arranged on an insulator module 13.

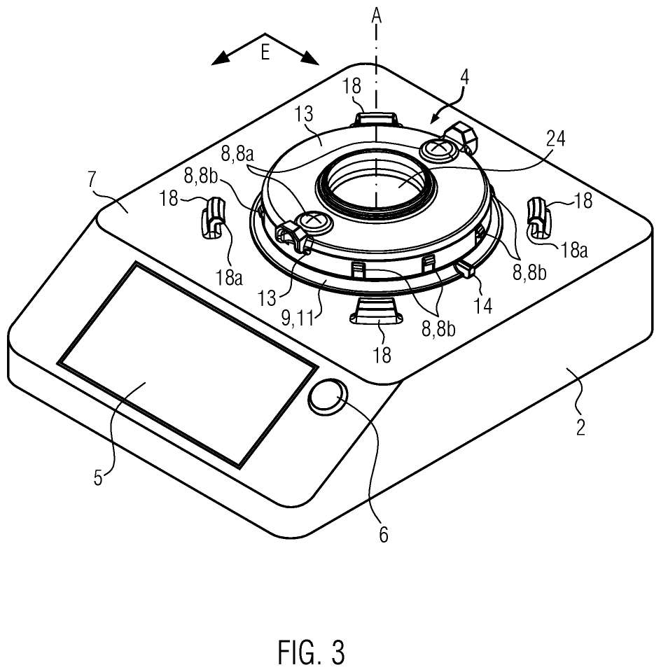

FIG. 3 shows an alternative embodiment example of a kitchen device base 2 in a perspective view. The collection area 4 is in turn provided on a top side 7 of the kitchen device base 2. The locking means 9 with the rotatable locking element 11 is arranged in the collection area 4. In this embodiment example, the locking element 11 is also arranged between the top side 7 of the kitchen device base 2 and an insulator module 13 arranged on the kitchen device base 2. The power contacts 8a and the auxiliary contacts 8b of the electrical interface 8 are arranged on the insulator module 13.

The insulator module 13 is essentially disc-shaped with a central recess 24. The power contacts 8a are arranged on a top side and the auxiliary contacts 8b are arranged on a peripheral side surface. The locking element 11, which is designed here as a locking ring, is rotatably retained. On the locking element 11, two driver contours 14, which are designed as carrier ribs here, are arranged opposite one another on the circumference of the locking element 11.

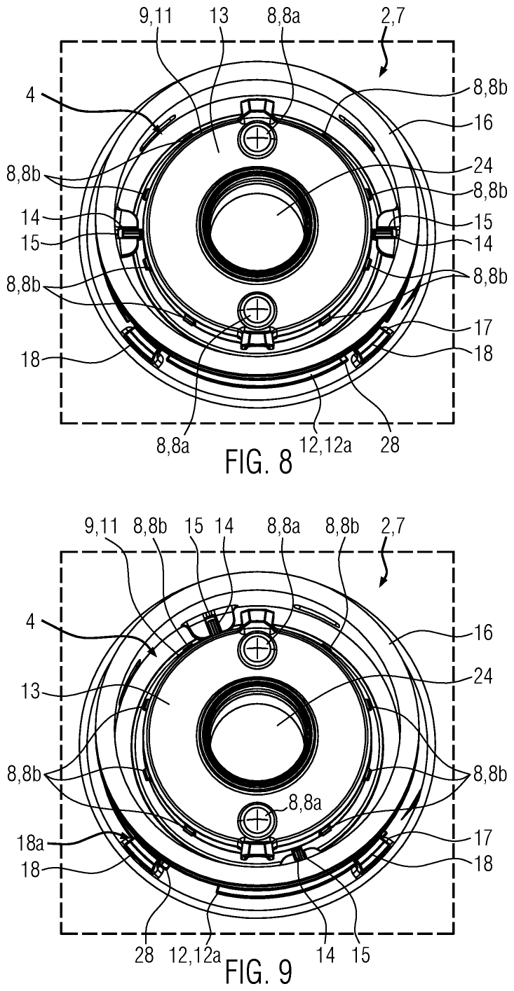

In the mounted state of a preparation module 3 in the collection area 4, the driver contours 14 engage driver counter-contours 15—depicted in FIGS. 8 and 9, and in FIG. 11, for example—, shown here in the form of carrier slots. The driver contour 14 interacts with the driver counter-contour 15 in a form-fitting manner, so that a rotational movement, in particular around the axis A, can be transmitted. The driver contours 14 and the driver contours 15 are arranged such that the preparation module 3 can be arranged in two different orientations in the collection area 4. The locking element 11 is driven by the drive unit 10, whereby in the applied state of a preparation module 3, the locking element 11 moves a locking counter-element 16 (see FIGS. 8, 9, 10 and 14) between a release position depicted in FIG. 8 and a locking position depicted in FIG. 9.

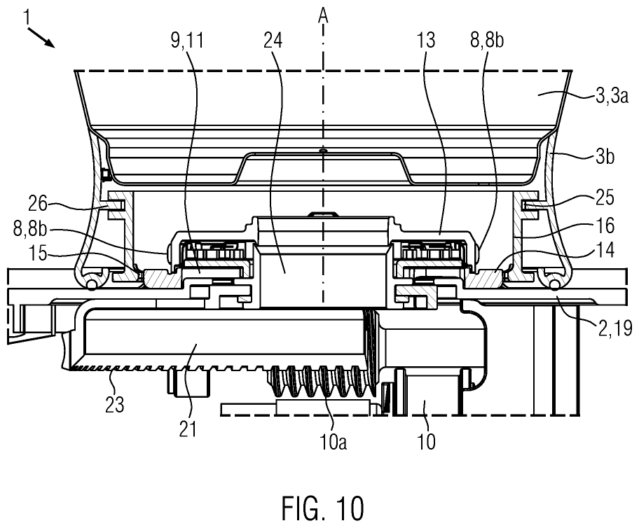

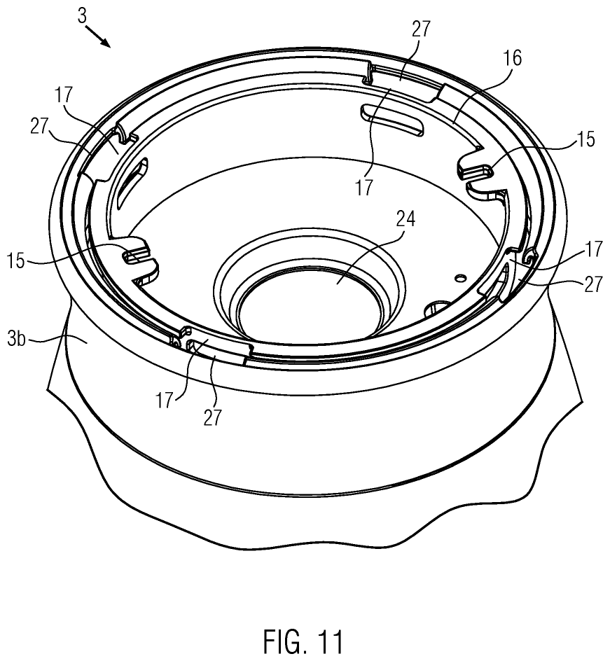

The locking counter-element 16, which is designed as a locking counter-ring according to FIG. 8, FIG. 9, FIG. 10, and FIG. 11, has a peripheral locking section 12, which is interrupted by the recesses 17. In the release position according to FIG. 8, the recesses 17 serve to enable the locking contours 18 provided on the top side 7 of the kitchen device base 2 to engage behind the locking sections 12 in order to interact with the locking sections 12 in a form-fitting manner in the locking position depicted in FIG. 9. The locking sections 12 each have a locking surface 12a which interacts with a locking counter-surface 18a in a form-fitting manner when in the locked state, according to FIG. 9. The locking contours 18 are essentially hook-shaped.

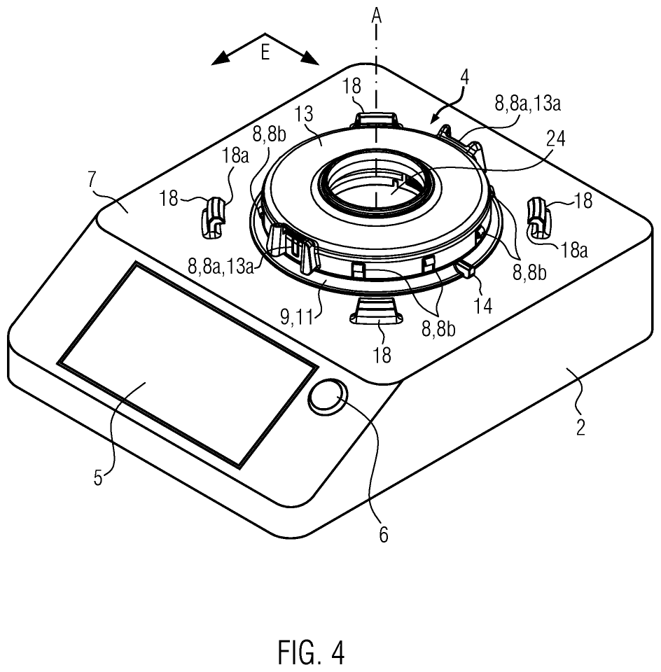

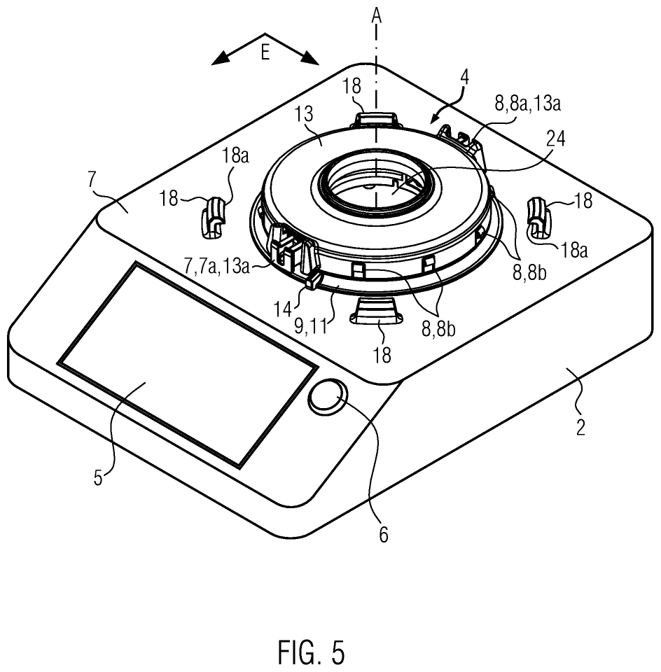

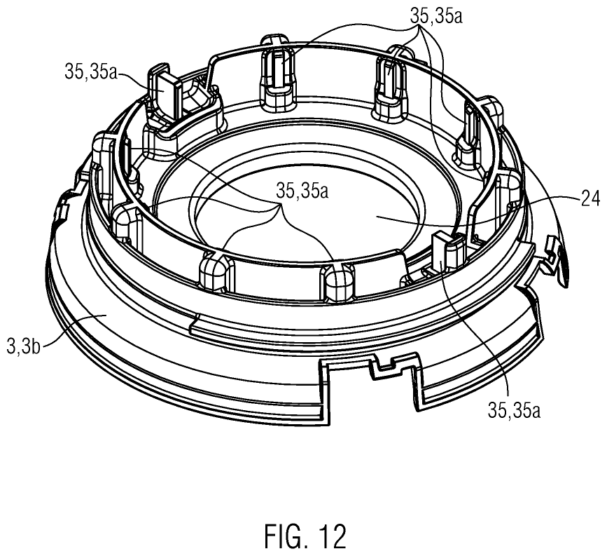

FIG. 4 and FIG. 5 show a further embodiment example of a kitchen device base 2 in which a locking means 9 with a locking element 11 is arranged in the collection area 4. The locking element 11 is designed as a locking ring and—as described for FIG. 3—is in particular arranged to be rotatable around a central axis A. The locking element 11 is movable below the power contacts 8a and the auxiliary contacts 8b. The insulator module 13 is designed in this embodiment example such that the power contacts 8a on insulators 13a are movable between a resting position depicted in FIG. 4, in which the insulators 13a have completely disappeared into the insulator module 13, and a contact position which is depicted in FIG. 5. In the contact position according to FIG. 5, the insulators 13a with the power contacts 8a protrude at least partially out of the insulator module 13, so that—with a preparation module 3 arranged in the collection area 4—they can be in electrical contact with the power counter-contacts 35a of the electrical counter-interface 35 of the preparation module 3, depicted as an example in FIG. 12.

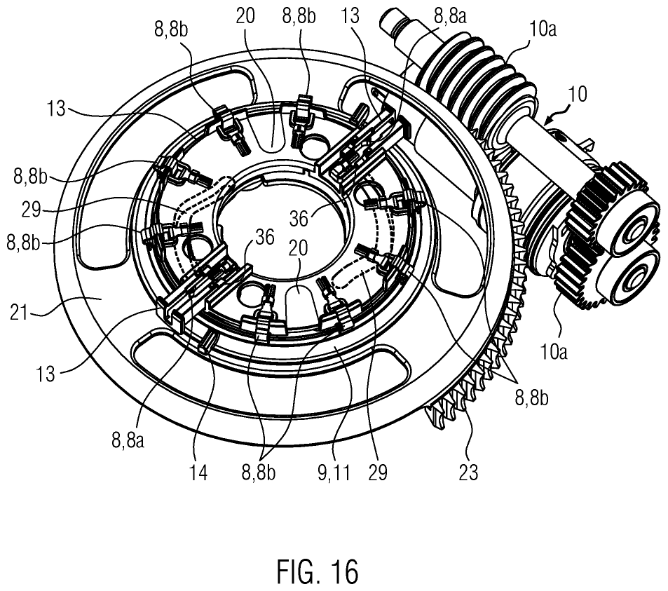

In the embodiment example in FIG. 4 and FIG. 5, the locking element 11 is in operational contact with a drive lever 21, depicted in FIG. 16. According to FIG. 16, the rotatable locking element 11 is arranged underneath the insulator module 13. The drive lever 21 is arranged underneath the locking element 11 and is essentially ring-shaped. The drive lever 21 is connected in a form-fitting manner to the locking element 11. The drive lever 21 has a curved rack gear 23, which is connected to the drive unit 10, in particular to a gear 10b of the drive unit 10. A movement of the drive lever 21, which is caused by the drive unit 10, consequently causes an identical movement, here rotation, of the locking element 11, i.e. between a release position and a locking position.

In the embodiment example according to FIG. 16, the drive lever 21 also has two connecting backplate recesses 29, which interact with the insulators 13a, in particular with drive protrusions 36 of the insulators 13a, such that—with a movement of the drive lever 21—the insulators 13a are moved simultaneously with a motion of the locking element 11 between a release position and a locking position, from a resting position (see FIG. 4) into a contact position (see FIG. 5). It is also provided that the movements only occur partially simultaneously or with a time delay.

If the locking element 11 is pivoted back from the locking position depicted in FIG. 5 into the release position depicted in FIG. 4, the insulators 13a are automatically inserted into the insulator module 13 by the action of the drive lever 21. It is thereby ensured that the power contacts 8a are kept safe from touch within the insulator module 13 when the preparation module 3 can be removed from the collection area 4. The movement between the release position—see FIG. 4—and a locking position—FIG. 5—takes place under the control of a control unit of the kitchen device base 2, which controls the drive unit 10.

The auxiliary contacts 8b make electrical contact with corresponding auxiliary counter-contacts 35b (see FIG. 12) of the preparation module 3 due to the placement of the preparation module 3. In the embodiment example of FIGS. 4 and 5, the locking element 11 has further driver contours 14, which interact with corresponding driver counter-contours 15 on the preparation module 3.

In the assembled state in a kitchen device base 2 according to FIG. 4 and FIG. 5, the preparation module 3 is locked to the kitchen device base 2 simultaneously and in particular automatically, and the power contacts 8a are electrically contacted with the power counter-contacts 35a of the preparation module 3. This embodiment example has the advantage that the forces for arranging the preparation module 3 in the collection area 4 of the kitchen device base 2 are markedly reduced, which increases the comfort of the user. Additionally, the preparation module 3 can be arranged in two different orientations in the collection area 4.

FIG. 6 shows an embodiment example of a base plate 19, depicted separately and from below, which in its assembled state is arranged underneath the insulator module 13 on the top side 7 of the kitchen device base 2, for example for an embodiment example according to FIG. 2 or FIG. 3. The drive unit 10 has a motor 10a as well as a gearbox 10c with multiple gears 10b. The drive unit 10 is mounted on the base plate 19. The locking element 11—separately depicted in FIG. 7—here a locking ring, penetrates the base plate 19 with two pins 20 approximately orthogonally. According to FIG. 6, the drive pins 20 are connected with a drive lever 21 in a form-fitting manner, in that the drive pins 20 engage in associated recesses 22 in the drive lever 21.

According to FIG. 6, the drive lever 21 has a curved rack gear 23, which is connected to the gear 10b, here a worm gear, of the drive unit 10. If the gear 10b of the drive unit 10 rotates, the rack gear 23 moves, causing the drive lever 21 and thus the locking element 11 on the other side of the base plate 19 to move from a release position to a locking position (see FIG. 9) or from of a locking position into a release position (see FIG. 8).

According to FIG. 8 and FIG. 9, the insulator module 13 has a central recess 24, which can be penetrated by a drive interface—not depicted—for the transmission of torque, for example to a tool in a preparation module 3.

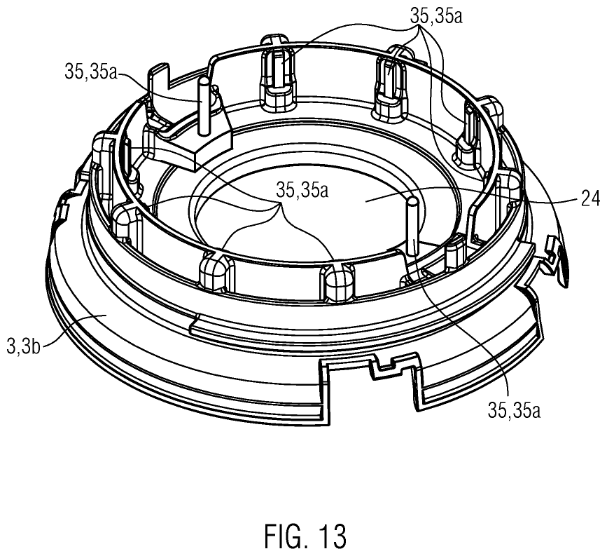

FIG. 10 shows a cross-section of a base plate 19 of a kitchen device base 2, in particular in accordance with FIG. 3 with an installed preparation module 3, which is embodied here as a preparation vessel with an interior preparation space 3a. The locking counter-element 16, here in the form of a locking counter-ring, has a circumferential groove 25, which interacts with an associated web 26 in a foot section 3b of the preparation module 3 such that the locking counter-element 16 can be rotated on the preparation module 3. According to FIG. 10, for the purpose of illustration only, the means for mechanical locking of the preparation module 3 to the kitchen device base 2 are depicted. Furthermore, for making electrical contact, the arrangement of an electrical counter-interface 36, in particular similar to that which is depicted in FIG. 12 or FIG. 13, is required.

As already described in relation to FIG. 8 and FIG. 9, the rotation of the locking counter-element 16 is effected in that the driver contours 14 of the locking element 11 interact with the driver counter-contours 15 on the locking counter-element 16. The rotation of the locking element 11 is in turn effected by a transmission of torque from the drive lever 21, which is in turn moved by the drive unit 10—see FIG. 6, for example.

In comparison with the state-of-the-art technology, this construction has the advantage that the preparation module 3 can be reliably and automatically lock to the kitchen device base 2 with an extremely flat design. The central recess 24 can be penetrated by a mechanical drive interface.

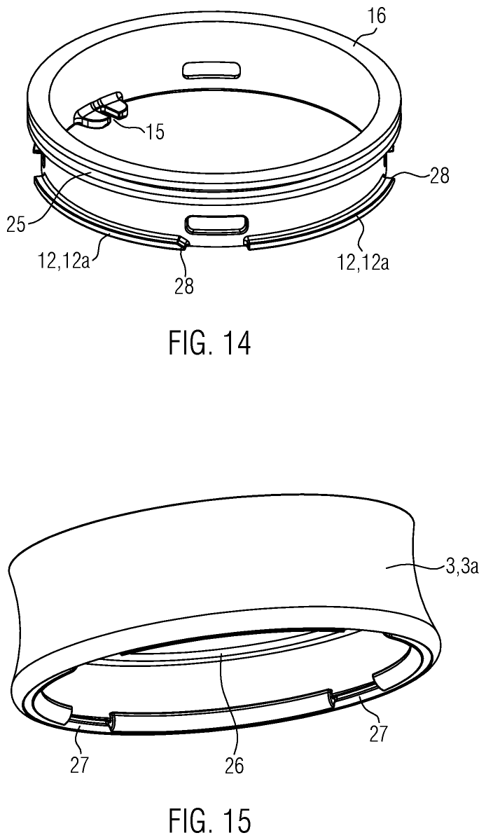

FIG. 11 shows an embodiment example of a preparation module 3 in a partial perspective view. The preparation module 3 is designed essentially in accordance with the embodiment example of FIG. 10. For the purpose of illustration, only the means for mechanical locking of the preparation module 3 to the kitchen device base 2 is depicted. Furthermore, for making electrical contact, the arrangement of an electrical counter-interface 8, in particular similar to that which is depicted in FIG. 11 or FIG. 14, is required. The recess 24 can be penetrated by a drive interface—not depicted—which can be arranged, which for example serves to transmit torque from a working unit, such as a motor, of the kitchen device base 2.

According to FIG. 11, the locking counter-element 16 is rotatably mounted in a foot section 3b of the preparation module 3. Recesses 17 are provided in the locking counter-element 16, which correspond with recesses 27 in the foot section 3b of the preparation module 3 in the depicted release position in order to enable the penetration of the locking contours 18 upon arrangement of the preparation module 3 in the collection area 4. The driver counter-contours 15, designed here as driver slots, are formed opposite one another on the circumference of the locking counter-element 16, so that the preparation module 3 can be placed in two different orientations on the kitchen device base 2. The locking counter-element 16 interacts with the kitchen device base 2 for locking purposes, as is described in relation to FIG. 4 and FIG. 5 as well as FIG. 8 and FIG. 9.

FIG. 12 shows an embodiment example of part of a foot section 3b for a preparation module 3. The foot section 3b has an electrical counter-interface 35, which has two power contacts 8a in the form of contact blades and eight auxiliary counter-contacts 35b in the form of contact surfaces. Such a foot section 3b can, for example, interact with a kitchen device base 2 according to FIG. 4 and FIG. 5. The foot section 3b can be arranged on preparation modules 3 with various functions. The auxiliary counter-contacts 35b make electrical contact upon being arranged in the collection area 4, and the power counter-contacts 35a only when the insulators 13a are in the contact position (see FIG. 5).

FIG. 13 shows a further embodiment example of part of a foot section 3b for a preparation module 3. The foot section 3b has an electrical counter-interface 35, which has two power contacts 8a in the form of contact pins and eight auxiliary counter-contacts 35b in the form of contact surfaces. Such a foot section 3b can, for example, interact with a kitchen device base 2 according to FIG. 2, FIG. 3, FIG. 8, and FIG. 9. The foot section 3b can be arranged on preparation modules 3 with various functions. The auxiliary counter-contacts 35b make electrical contact upon being arranged in the collection area 4, and the power counter-contacts 35a chronologically after the auxiliary counter-contacts 35b.

FIG. 14 shows the locking counter-element 16 for a preparation module 3 according to FIG. 8, FIG. 9, and FIG. 11 in a perspective view. The locking section 12 with the locking surfaces 12a is interrupted by the recesses 17. Depending on the rotational direction between the release position and the locking position, the locking sections 12 have lead-in chamfers 28 that simplify the form-fitting interaction with the locking contours 18 on the kitchen device base 2—see FIG. 3, FIG. 4, and FIG. 5 for example.

FIG. 15 shows an embodiment example of part of a foot section 3b of a preparation module 3. The recesses 27 serve to allow the penetration of the locking contours 18 of the kitchen device base 2 during insertion of a preparation module 3 in the collection area 4. The web 26 interacts with the groove 25—see FIG. 12—such that the locking counter-element 16 in the form of a locking ring is rotatably mounted on the foot section 3b of the preparation module 3.

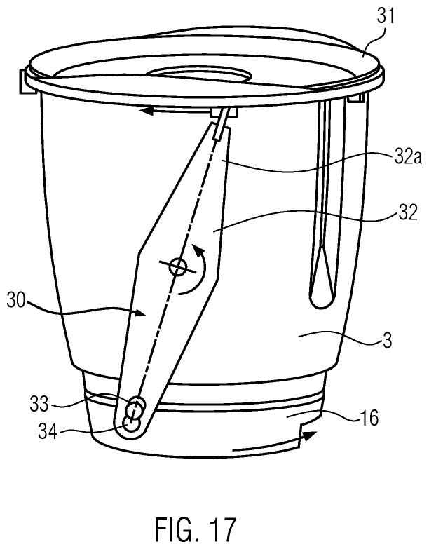

FIG. 17 shows an embodiment example of a preparation module in a partially assembled state. A lid locking device 30 interacts with the locking counter-element 16, whereby the lid locking device 30 also locks a lid 31 which closes the preparation space 3a with the preparation module 3 upon rotation of the locking counter-element 16 from a release position into a locking position. Embodiment examples are also provided in which the lid locking device 30 is designed such that, in a first step, the preparation module 3 is locked to the kitchen device base 2 so that the lid 31 can be removed when the preparation module is locked, and that the lid 31 can be locked to the preparation module 3 only in a second step. The lid locking device 30 has a pivotably mounted functional element 32 that can be moved from a release position depicted in the direction of the arrow into a locking position. An actuator pin 33 is arranged on the locking counter-element 16, which engages in a corresponding recess 34 on the functional element 32 in order to pivot the functional element 32. The head area 32a of the functional element 32 rotates the lid 31 so that it locks in a form-fitting manner with the preparation module 3.

The invention is not limited to the depicted and described embodiment examples, but also encompasses all embodiments of that have the same effect within the meaning of the invention. It is explicitly noted that the embodiment examples are not limited to all individual features in combination; rather each individual sub-feature can be meaningful to the invention independently of all other sub-features. Furthermore, the invention has not yet been restricted to the combination of features as described in any embodiment, but can also be defined by any other desired combination of features out of all of the features described in total. This means that in principle practically every individual feature of an embodiment can be omitted or replaced by at least one individual feature described elsewhere in this application. In other words, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A kitchen device base with comprising at least one collection area for at least one preparation module, whereby the collection area has at least one locking means for the purpose of mechanical locking of the preparation module,
wherein the locking means has at least one drive unit and at least one movably mounted locking element, that the locking element can be moved at least indirectly by means of the drive unit, at least between a release position and a locking position, that in the release position the preparation module can be arranged in at least two different orientations in the collection area, and that in the locking position the preparation module is locked to the kitchen device base.

2. The kitchen device base according to claim 1, wherein the locking element can be rotated by the drive unit, at least indirectly or directly.

3. The kitchen device base according to claim 1, the kitchen device further comprising at least one drive lever, such that the drive unit interacts with the drive lever in order to move the locking element.

4. The kitchen device base according to claim 3, wherein the locking element is connected to the drive lever in a form-fitting manner.

5. The kitchen device base according to claim 1, wherein the locking element can be moved in a locking plane (E),
wherein preferably that the locking plane (E) is oriented essentially parallel to a stand space of the kitchen device base.

6. The kitchen device base according to claim 1, wherein the locking element has at least one locking section, and that the locking section in the locking position interacts in a form-fitting locking manner with at least one locking counter-section of the preparation module when the preparation module is in the collection area.

7. The kitchen device base according to claim 1, wherein the locking element has at least one driver contour and that the driver contour is designed for interaction with a driver counter-contour, on a locking counter-element on the preparation module.

8. The kitchen device base according to claim 1, wherein at least one electrical interface is present, the electrical interface having at least two power contacts and at least one auxiliary contact, and that at least one of the power contacts and/or at least the auxiliary contact of the electrical interface can be moved from a resting position at least in the direction of a contact position on the kitchen device base, during and/or after the arrangement of the preparation module in the collection area, by means of the drive unit.

9. The kitchen device base according to claim 8, wherein the movement of the at least one power contact and/or at least the auxiliary contact is effected at least indirectly by the drive lever.

10. A preparation module for arranging in a collection area of a kitchen device base, wherein a rotatably mounted locking counter-element is present, that the locking counter-element can be moved by a locking element of the kitchen device base at least between a locking position and a release position, and that the locking counter-element is configured such that the locking element of the kitchen device base can engage in a form-fitting manner in at least two positions on the locking counter-element for movement.

11. The preparation module according to claim 10, wherein the preparation module has at least one electrical counter-interface for making electrical contact with an electrical interface of the kitchen device base and/or that the locking counter-element has at least two driver counter-contours configured as driver gaps.

12. The preparation module according to claim 10 wherein the locking counter-element has at least one circumferential groove, and that the locking counter-element is rotatably mounted by means of the groove.

13. The preparation module according to claim 10, wherein at least one preparation space is present, the preparation space configured to be closed with at least one lid,
wherein at least one lid locking device is present, the locking counter-element is operatively connected with the lid locking device, so that at least one lid that can be arranged on the preparation module can be locked with the lid locking device, at least in the locking position of the locking counter-element.

14. A kitchen device with at least one kitchen device base, and at least one preparation module according to claim 10.

15. The kitchen device according to claim 14, wherein the locking sections of the locking counter-element interact with locking contours on the kitchen device base in the collection area, for the purpose of locking the preparation module to the kitchen device base.

16. The kitchen device base according to claim 2, wherein preferably the locking element is designed as a locking ring.

17. The kitchen device base according to claim 4, wherein the locking element at least partially penetrates a base plate of the kitchen device base to form the connection.

18. The kitchen device base according to claim 5, wherein the locking plane (E) is oriented essentially parallel to a top side of the kitchen device base.

19. The preparation module according to claim 11, wherein the driver counter-contours are arranged opposite one another.

20. The preparation module according to claim 12, wherein the groove interacts with at least one circumferential web.

21. The kitchen device base according to claim 3, wherein the drive unit has at least one motor and at least one gear, and that the gear is operationally connected to the drive lever.

22. The kitchen device base according to claim 9, wherein the movement is effected such that the locking element is moved at least partially simultaneously with the at least one power contact and/or at least with the auxiliary contact, in order to lock a preparation module, or that the locking element is moved before or after the at least one power contact and/or at least the auxiliary contact, in order to lock a preparation module.
